(19) United States
(12) Patent Application Publication
(10) Pub. No.: US 2005/0264539 A1
(43) Pub. Date: Dec. 1, 2005

(54) Electronic apparatus

(76) Inventor: Hiroshi Nakamura, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/137,320

(22) Filed: May 25, 2005

(30) Foreign Application Priority Data
May 31, 2004 (JP) 2004-162084

(51) Int. Cl. G09G 5/00

(52) U.S. Cl. 345/173

(57) ABSTRACT

A portable computer as an example of an electronic apparatus has a main unit, and display unit including a liquid crystal display panel. A mounting base is formed on the upper surface of the main unit. The mounting base is formed over the front and rear halves of the upper surface of the main unit, in an area occupying more than half of the area of the upper surface. A pressure-sensitive input tablet is provided on the whole surface of the input area of an input unit to be mounted on the mounting base. The pressure-sensitive input tablet has a sheet member having a printed design indicating an input position.

### CROSS-REFERENCE TO RELATED APPLICATIONS

This application is based upon and claims the benefit of priority from prior Japanese Patent Application No. 2004-162084, filed May 31, 2004, the entire contents of which are incorporated herein by reference.

### BACKGROUND

1. Field

The present invention relates to an electronic apparatus such as a portable computer having a main unit and an openable display unit.

2. Description of the Related Art

There is a conventional known electronic apparatus such as a portable computer having a compact tablet unit contained in a main unit with a keyboard. An openable display unit having a liquid crystal display panel is hinged to the main unit.

Jpn. Pat. Appln. KOKAI Publication No. 6-187090 discloses an electronic apparatus having a main body and an external tablet unit constructed separately from the main unit. The tablet unit is connected to the main unit through a harness member. Jpn. Pat. Appln. KOKAI Publications Nos. 5-210725 and 5-53711 disclose an electronic apparatus having only a tablet unit provided on the upper surface of a main unit.

In an electronic apparatus called a compatible-type, a tablet unit is included in a display unit. A compatible-type electronic apparatus is provided with a 2-way hinge having a first horizontal axis and a second vertical axis at the central portion of the rear end of a main unit. The display unit is movably attached to the main unit with the hinge. Namely, the display unit is rotatable around the first axis, and rotatable around the second axis. The compatible-type electronic apparatus permits input from the tablet unit with the display unit raised. The compatible electronic apparatus also permits input from the tablet unit with the display unit closed overlaying on the main unit to make the input area of the tablet unit face up.

In a conventional electronic apparatus having a keyboard and a compact tablet unit contained in a main unit, the tablet area is narrow, which makes drawing a detailed picture on the tablet difficult, and the keyboard cannot be easily replaced. Further, a conventional keyboard has a clearance between key-tops causing dust and liquid to enter, and is poor in watertightness.

In the electronic apparatus having an external tablet unit described in the Jpn. Pat. Appln. KOKAI Publication No. 6-187090, the tablet unit is connected to a main unit through a harness member. Thus, the external tablet unit is inconvenient to carry, and needs a wide setting area.

In the electronic apparatus having only a tablet unit in a main unit described in the Jpn. Pat. Appln. KOKAI Publication Nos. 5-210725 and 5-53711, operability of entering characters with fingers is worse compared with a keyboard.

In the compatible-type electronic apparatus, a display unit having a tablet unit is unstable when making input from a tablet unit with a display unit raised, and the input operation is difficult. For overlaying a display unit on a main unit to make the input area of a tablet unit face up, it is necessary to move the display unit around the first axis of the hinge and swing 180° around the second axis. This is troublesome in handling the display unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a portable computer according to an embodiment of the present invention, with an input unit removed;

FIG. 2 is a plane view of the portable computer shown in FIG. 1, with an input unit mounted in a main unit;

FIG. 3 is a sectional view of the main unit and input unit taken along lines F3-F3 of FIG. 2;

FIG. 4 is a plane view of a main unit of the portable computer shown in FIG. 1;

FIG. 5 is a partially magnified sectional view of the main unit indicated by F5 in FIG. 3;

FIG. 6 is a sectional view of a part of the input unit shown in FIG. 1;

FIG. 7 is a sectional view of a part of the main unit taken along lines F7-F7 of FIG. 2;

FIG. 8 is a sectional view of a part of the main unit taken along lines F8-F8 of FIG. 2;

FIG. 9 is a sectional view of a part of the input unit taken along lines F9-F9 of FIG. 2;

FIG. 10 is a plane view of another example of a cover sheet member used in the input unit; and

FIG. 11 is a sectional view of another example of the input unit mounted in the main unit.

### DETAILED DESCRIPTION OF THE INVENTION

Hereinafter embodiments of the present invention will be explained based on the accompanied drawings applied to a portable computer.

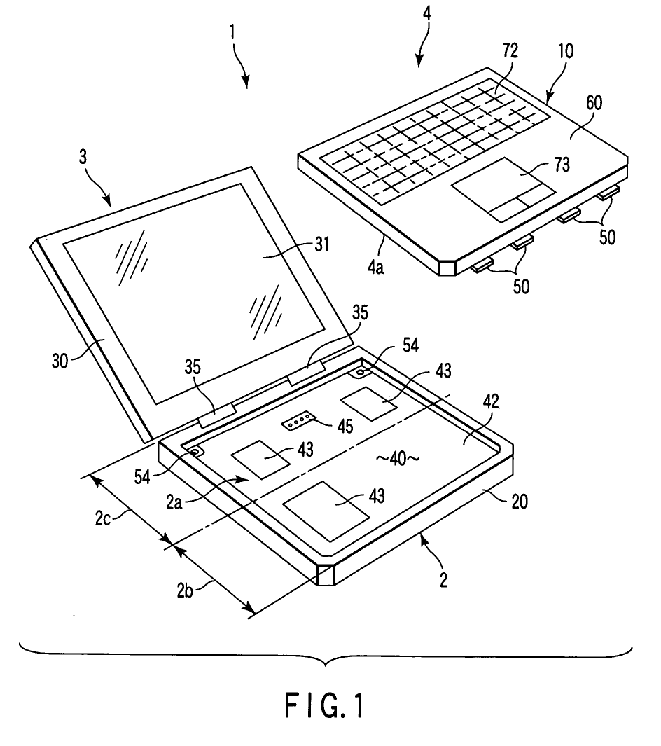

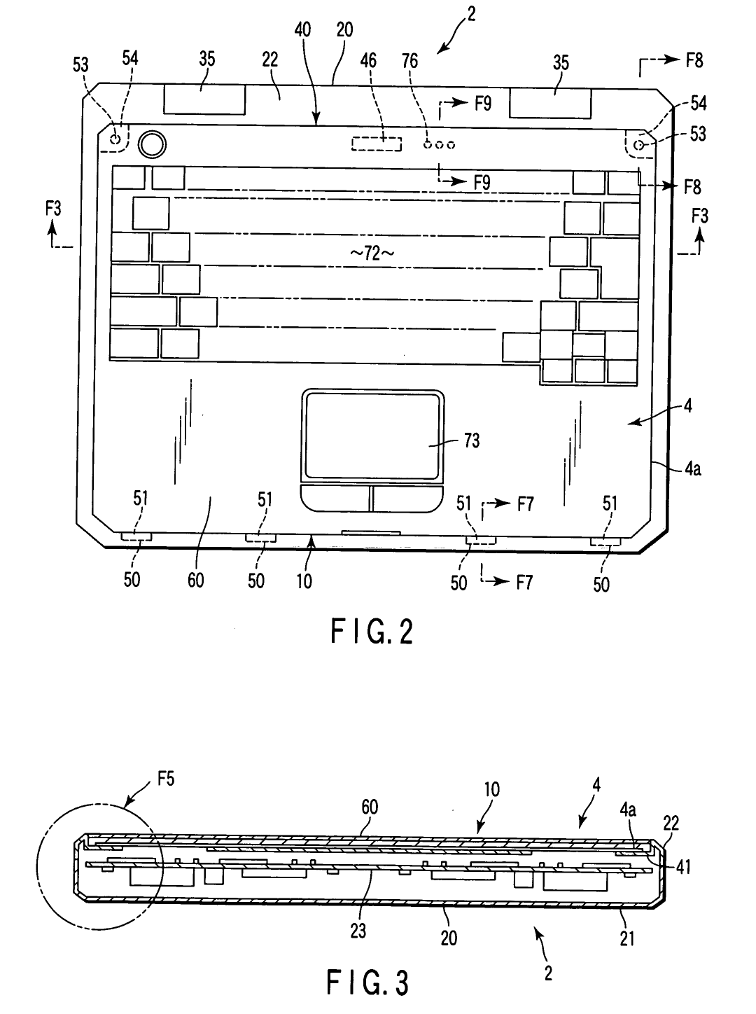

FIG. 1 shows a portable computer 1 as an example of an electronic apparatus. The portable computer 1 comprises a main unit 2, a display unit 3, and an input unit 4. The input unit 4 is removably mounted in the main unit 2. FIG. 1 shows the input unit 4 removed from the main unit 2. FIGS. 2 and 3 show the input unit 4 mounted in the main unit 2.

A tablet unit 10 is an example of the input unit 4. A keyboard 11 shown in FIG. 11 is another example of the input unit 4. The tablet unit 10 and keyboard 11 will be explained later.

The main unit 2 has a flat box-like housing 20, as shown in FIG. 3. The housing 20 comprises a base member 21 forming a lower half part of the housing 20, and a top cover 22 forming an upper half part of the housing. The housing 20 contains a circuit board 23 (FIG. 3) such as a system board. On the circuit board 23, electronic components for controlling the portable computer 1 are mounted.

The display unit 3 shown in FIG. 1 comprises a flat box-like case 30, a liquid crystal display panel 31 provided in the case 30, a backlight (not shown) contained in the case 30, and a circuit board (not shown) provided with electronic components for driving the backlight. The case 30 has substantially the same area as an upper surface 2a of the main unit 2. An image display surface, i.e., the front surface of the liquid crystal display panel 31, is exposed to the outside of the case 30.

The display unit is attached to the main unit 2 with a hinge 35 provided at the rear end of the main unit 2, so as to open and close in the vertical direction relative to the main unit 2. Namely, the display unit 3 is movable relative to the main unit 2 from a closed position to an opened position, and vice versa. When the display unit 3 is closed, the unit is overlaid on the main unit 2 with the image display surface of the liquid crystal display unit 31 faced down. At this closed position, the upper surface of the main unit 2 is covered with the display unit 3.

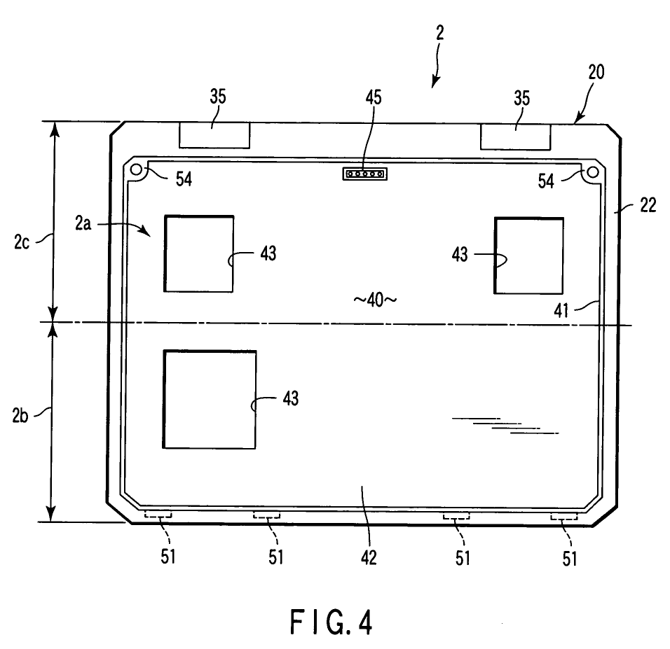

A mounting base 40 for mounting the input unit 4 is formed on the upper surface 2a of the main unit 2, or the upper surface of the housing 20. As shown in FIG. 1 and FIG. 4, the mounting base 40 is formed over a front half 2b and a rear half 2c of the upper surface 2a of the main unit 2, in an area occupying more than half of the area of the upper surface 2a of the main unit 2.

The mounting base 40 has a recess opened to the upper surface of the top cover 22. Around the recess, a holder wall 41 is formed to hold a periphery 4a of the input unit 4. The holder wall 41 holds the input unit 4 when the input unit 4 is mounted on the mounting base 40 and the periphery 4a of the input unit 4 is placed on the holder wall 41.

A cover wall 42 is formed inside the mounting base 40. When the input unit 4 is removed from the main unit 2, the circuit board 23 is covered with the cover wall 42. The cover wall 42 has an opening 43 at positions corresponding to electronic components mounted on the circuit board 23. These electronic components can be handled from the upper side of the cover wall 42 through the opening 43. The cover wall 42 may be formed as one body with the housing 20. Or, a sheet-like cover wall made of electrically insulated material formed separately from the housing 20 may be placed on the circuit board 23.

A first connector 45 is provided in the main unit 2, as shown in FIG. 4. The first connector 45 is connected to a second connector 46 (shown in FIG. 2) when the input unit 4 is mounted on the mounting base 40. The second connector 46 is provided in the input unit 4. The input unit 4 is electrically connected to the circuit board 23 of the main unit 2 through the connectors 45 and 46. The input unit 4 may be connected to the circuit board 23 through a harness member (not shown).

A circuitry of the main unit 2 including the first connector 45 has a means for detecting a sort of the input unit 4. A jumper circuit is an example of the means for detecting a sort of the input unit 4. It is permitted to provide software to make the operator select a menu displayed on the screen of the display unit, as a means for selecting a sort of the input unit 4. The software is installed in the main unit 2.

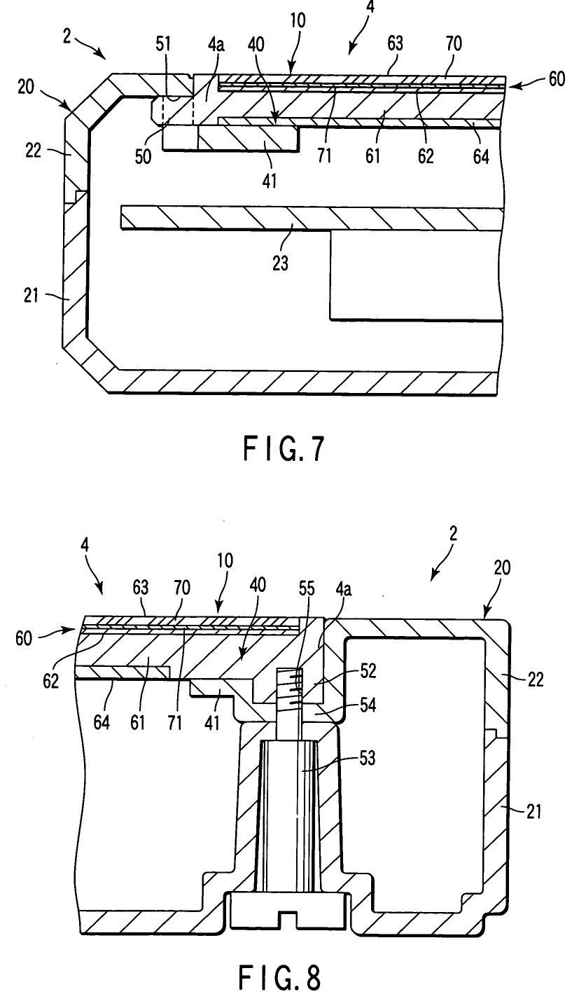

As shown in FIG. 7, one end of the input unit 4 is provided with an engaging portion 50 formed as a projection or the like. The engaging portion 50 engages with a receiving portion formed as a hole or the like in the housing 20 of the main unit 2. As shown in FIG. 8, the other end of the input unit 4 is provided with a fixing portion 52. The fixing portion 52 is fixed to a mounting portion 54 provided in the housing 20, with a screw member 53.

A screw hole 55 (shown in FIG. 8) is formed at the rear end of the tablet unit 10. The tip of the screw member 53 inserted from the bottom side of the housing 20 is inserted into the screw hole 55. The fixing portion 52 of the input unit 4 is fixed to the mounting portion 54 of the housing 20 by inserting the screw member 53 into the screw hole 55. The input unit 4 can be easily dismounted from the main unit 2 by removing the screw member 53.

The housing 20 and input unit 4 can be made watertight by bringing the holder wall 41 into close contact with the periphery 4a of the input unit 4 not to make a clearance therebetween. The watertightness can be increased by inserting a sealing member between the housing 20 and the periphery 4a of the input unit 4.

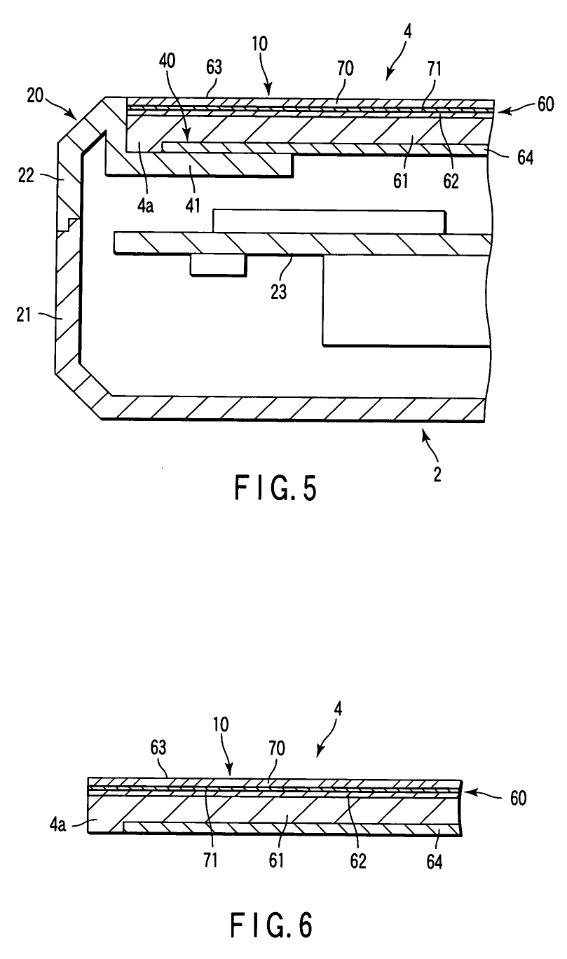

The tablet unit 10 shown in FIG. 5-FIG. 8 has a pressure-sensitive input tablet 60. The pressure-sensitive input tablet 60 occupies the whole input area of the tablet unit 10. Therefore, almost the whole area of the upper surface of the pressure-sensitive input tablet 60 can be used as an area for the tablet input.

The pressure-sensitive input tablet 60 comprises a support base 61, a pressure-sensitive sheet 62, and a cover sheet member 63, for example. The support base 61 serves as a base of the tablet 60. The pressure-sensitive sheet 62 is provided on the support base 61. The cover sheet member 63 has a printed design or the like to indicate an input position of the pressure-sensitive sheet 62. The cover sheet member 63 is an example of a sheet member mentioned in the present invention. The tablet unit 10 is also provided with an electromagnetic tablet 64 under the support base 61.

The support base 61 has an area over almost the whole surface of the pressure-sensitive input tablet 60. If the support base is made of relatively soft synthetic resin, for example, this enables soft and smooth operation.

The cover sheet member 63 comprises a surface sheet 70 and a print sheet 71, for example. The surface sheet 70 is made of an optically transparent material (e.g., a transparent sheet made of synthetic resin). The print sheet 71 is inserted between the pressure-sensitive sheet 62 and surface sheet 70. The print sheet 71 has a keyboard print portion 72 (shown in FIG. 2) where a keyboard pattern is printed and a print touch pad 73 where a touch pad pattern is printed at predetermined positions.

The print sheet 71 is removable from the pressure-sensitive sheet 62 and surface sheet 70. With the cover sheet member 63 configured as above, a desired print sheet 71 can be laid on the pressure-sensitive sheet 62 by pulling up the surface sheet 70. Therefore, the cover sheet member 63 having a desired design can be obtained.

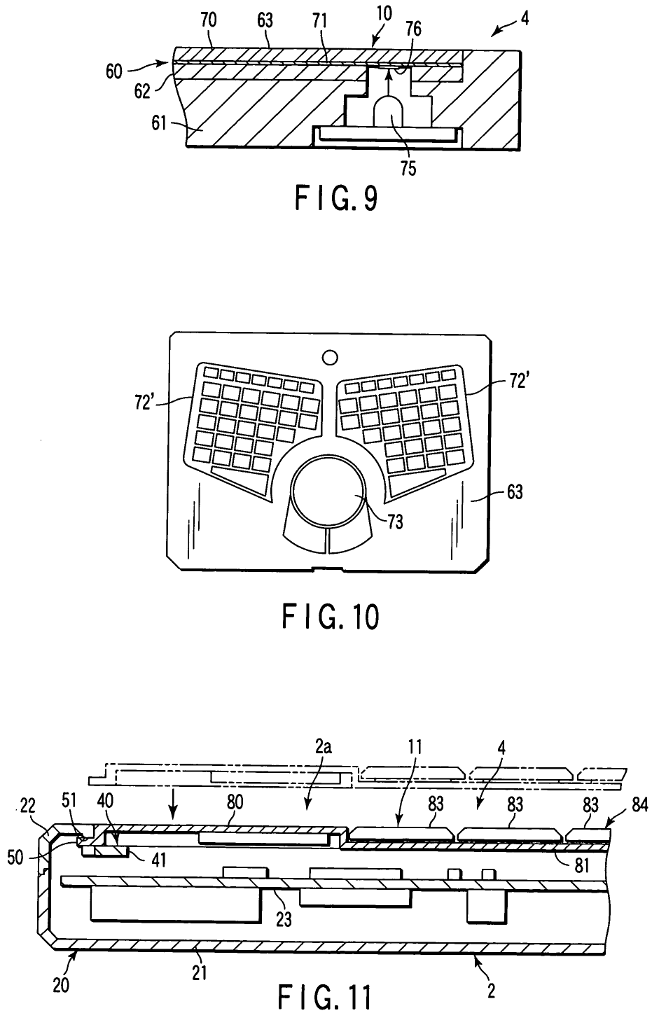

As shown in FIG. 9, the tablet unit 10 has a photosensor 75. The photosensor 75 is an example of a means for detecting a sort of the print sheet 71. The photosensor 75 optically reads an identify mark 76 print on the print sheet 71, and identifies the sort of the print sheet 71.

As another means for detecting a sort of the print sheet 71, it is permitted to use movable pins energized in a direction of projecting from a support base 61 and a switch operated according to the projecting/sinking state of the movable pins. The print sheet 71 has detection holes at positions corresponding to the movable pins. The switch generates a signal according to the projecting/sinking state of each movable pin relative to the detection hole. Based on this signal, a sort of the print sheet 71 can be detected. Or, a sort of the print sheet 71 can be detected by reading a magnetic mark formed on the print sheet 71 by a magnetic sensor.

The cover sheet member 63 of this embodiment comprises two sheets, a transparent surface sheet 70 and a print sheet 71 having a picture print. As another form of the cover sheet member, it is permitted to make one cover sheet member having a printed design removable from the pressure-sensitive sheet 62. In that case, a design can be changed by replacing a cover sheet member. Thus, the cover sheet member 63 can be replaced by the user of the portable computer 1 as needed or as desired.

The input area of the pressure-sensitive input tablet 60 can be easily configured with software of the portable computer 1. Therefore, a design printed on the cover sheet member 63 can take various forms in the input area of the pressure-sensitive input tablet 60 according to the input position.

A keyboard layout of an ordinary portable computer is one example of a design printed on the cover sheet member 63. Other examples include a separate-type keyboard layout 72′ shown in FIG. 10, a keyboard layout comprising different sorts of characters, a print indicating any symbol, and other prints having various designs for various purposes. Namely, a design indicating the input position of the pressure-sensitive input table 60 is printed.

FIG. 11 shows the case of using the keyboard 11 as another example of the input unit 4. A double-dashed chain line in FIG. 11 indicates the state that the keyboard 11 is removed from the main unit 2. The keyboard 11 has a frame member 81 having a palm rest portion 80, a key-top group 84 comprising key-tops 83 arranged on the frame member 81, and contacts (not shown) corresponding to the key-tops 83. When one of the key-tops 83 is pressed, a predetermined electric signal corresponding to the pressed key-top is generated.

The engaging portion 50 is provided at the front end of the frame member 81 of the keyboard 11, as in the above-mentioned embodiment. The engaging portion 50 is engaged at one end of the mounting base 40 of the housing 20. A fixing portion (not shown) is provided at the rear end of the frame member 81. The fixing portion is fixed to the other end of the mounting base 40 with a screw member or the like. The keyboard 11 configured as described above can also be removed from the mounting base 40 of the housing 20, like the tablet unit 10.

Next, explanation will be given on the function of the portable computer 1 of this embodiment.

FIG. 2 shows an example of the tablet unit 10 mounted on the mounting base 40 of the portable computer 1. In this case, it is possible to input from the tablet by using almost the whole surface of the tablet unit 10 as an input area. When a pressure is applied onto the cover sheet member 63 shown in FIG. 5 with a finger or a writing tool, an electric signal is generated from the pressure-sensitive sheet 62 according to the coordinates of the position where the pressure is applied. Based on this electric signal output, the coordinates of the position where the pressure is applied are inputted to the circuitry of the circuit board 23.

For example, it is assumed that the pressure-sensitive input tablet 60 is set in input mode for the keyboard print 72. When the keyboard print 72 is pressed with a finger, the pressed print key is inputted, just like pressing a key. Assuming that the pressure-sensitive input tablet 60 is set in input mode for writing characters or pictures, and a character or picture is written on the cover sheet member 63 with a finger or a writing tool, the pressure-sensitive sheet 62 detects the coordinates of the positional coordinates where the pressure is applied, and the written character or picture can be entered.

The pressure-sensitive input tablet 60 is placed on the whole input area of the upper surface of the input unit 4. Therefore, a wide area can be used as a tablet input area, enabling to draw fine pictures. As the tablet unit 10 is contained in the main unit 2, the tablet input is easy to use when used in the state that the display unit 3 is raised, compared with the case where a tablet unit is contained in the display unit 3. As the tablet unit 10 is contained in the main unit 2 as one body, the unit is easy to carry and the area occupied by the whole unit is small, compared with an external tablet unit.

It is permitted to provide software to automatically switch first and second input modes according to the contents displayed on the liquid crystal display panel 31 of the display unit 3. The first input mode is for the input by using the keyboard print 72, just like operating real keys. The second input mode is a tablet input mode for writing characters and pictures.

The tablet unit 10 of this embodiment has an electromagnetic tablet 64. Therefore, entry from the tablet is possible by using an input tool for operating the electromagnetic tablet 64. In this case, it is also possible to make the input operation (hovering) by floating an input tool from the cover sheet member 63.

The tablet unit 10 is not provided key-tops such as those of a keyboard, and is covered with the cover sheet member 63 having a smooth surface. Therefore, the tablet unit 10 is highly watertight and dustproof, and has an easy-to-clean surface.

The tablet unit 10 can be removed from the mounting base 40 of the main unit 2, and the keyboard 11 (shown in FIG. 11) can be mounted on the mounting base 40. When the keyboard 11 is mounted, key input is possible from the keyboard 11 by pressing the key-top 83 with a finger.

The portable computer 1 of this embodiment permits the user to select and use the input unit 4 as needed or as desired. Namely, the user can select one mode for using the tablet unit 10 and the other mode for using the keyboard 11.

When the tablet unit 10 is used, the user can input according to a design of the cover sheet member 63 by replacing the cover sheet member 63 to meet the input position. For example, by using the keyboard print 72 in addition to the tablet input for writing characters and pictures, the user can make various inputs including key-in with a finger, and inputs for on/off operations. If necessary, the user can selectively use the pressure-sensitive tablet 60 and electromagnetic tablet 64. A electrostatic input tablet may be used with the tablet unit 10.

As explained hereinbefore, the functions of an electronic apparatus can be diversified furthermore according to the embodiment of the invention. For example, it is possible to provide a tablet unit in a wide area of the upper surface of a main unit.

An electronic apparatus according to the invention is not limited to a portable computer. Any apparatus can be used, if it has a main unit and display unit, and an input unit can be mounted in a main unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus comprising:
a main unit having a housing and a circuit board contained in the housing; and
a display unit which has a liquid crystal display panel, and is attached to the main unit;
wherein the electronic apparatus has a mounting base formed over a front half and a rear half of the upper surface of the main unit, in an area occupying more than half of the upper surface area; and
an input unit which is to be mounted on the mounting base, and has an input area that comprises of a pressure-sensitive input tablet.

2. The electronic apparatus according to claim 1, further comprising:
an engaging portion which is provided at one end of the input unit, and engages with housing of the main unit; and
a fixing portion which is provided at the other end of the input unit, and is fixed to the housing of the main unit,
wherein the input unit is held removable from the main unit, with the engaging portion and fixing portion.

3. The electronic apparatus according to claim 1, wherein the pressure-sensitive input tablet has a pressure-sensitive sheet to sense a pressure and output an electric signal, and a sheet member having a design indicating an input position of the pressure-sensitive sheet.

4. The electronic apparatus according to claim 3, wherein the pressure-sensitive input tablet has a detection means for detecting a sort of the sheet member.

5. The electronic apparatus according to claim 3, wherein the sheet member has a transparent surface sheet and a print sheet to be inserted between the surface sheet and the pressure-sensitive sheet, and the print sheet is removable from the surface sheet and pressure-sensitive sheet.

6. The electronic apparatus according to claim 3, wherein the sheet member has a keyboard print at a predetermined position.

7. The electronic apparatus according to claim 3, wherein the input unit has an electromagnetic tablet.

8. An electronic apparatus comprising:
a main unit having a housing and a circuit board contained in the housing; and
a display unit which has a liquid crystal display panel, and is attached to the main unit;
wherein the electronic apparatus has a mounting base formed over a front half and a rear half of the upper surface of the main unit, in an area occupying more than half of the upper surface area; and
an input unit which is to be mounted on the mounting base, and removable from the mounting base of the main unit.

9. The electronic apparatus according to claim 8, wherein the input unit has at least one of a pressure-sensitive input tablet, an electromagnetic tablet, an electrostatic input tablet, and a keyboard; and these input units are selectively mountable on the mounting base.

10. An electronic apparatus comprising:
a main unit having a housing and a circuit board contained in the housing; and
a display unit which has a liquid crystal display panel, and is attached to the main unit;
wherein the electronic apparatus has a mounting base formed over a front half and a rear half on the upper surface of the main unit, in an area occupying more than half of the upper surface area; and a tablet unit or keyboard is selectively mountable on the mounting base.

11. The electronic apparatus according to claim 10, wherein the tablet unit has a pressure-sensitive sheet to sense a pressure and output an electric signal, and a sheet member having a design indicating an input position of the pressure-sensitive sheet; and a keyboard design is printed at a predetermined position on the sheet member.
